(19) United States
(12) Patent Application Publication
(10) Pub. No.: US 2008/0076005 A1
(43) Pub. Date: Mar. 27, 2008

(54) Fuel cell fluid distribution system

(75) Inventors: Stephane Levesque, Montreal (CA); Raymond Roberge, Boucherville (CA)

Correspondence Address: Raymond Roberge, 2424 rue Des Carrieres, Montreal, QC, H2G 1X7, US

(73) Assignees: Michel Bitton; EnergyOr Technologies Inc.

(21) Appl. No.: 11/525,149

(22) Filed: Sep. 22, 2006

(51) Int. Cl. H01M 8/02; H01M 8/04; H01M 8/10; H01M 2/08

(52) U.S. Cl. 429/38; 429/30; 429/26; 429/35

(57) ABSTRACT

The dominant fuel cell design is based on using separator plates with flow fields to distribute the reaction gases parallel to the membrane. In our invention the solid electrolyte membrane fuel cell has a multitude of conduits that penetrate the catalyst coated membranes and the porous gas diffusion layers in a perpendicular direction, each conduit separated by an active area. The conduits are distributed in a repeatable parallelogram unit to create a two dimensional pattern. The conduits have appropriately positioned integrated gaskets to provide reactant gases to the anode (fuel) or cathode (oxidant) and to ensure that the anode fuel is prevented from entering the cathode side of the membrane and vice-versa. A separate conduit (in/out) for the water cooling can be added or the water cooling can be integrated to the air exhaust or the hydrogen exhaust to extract the heat from the electrochemical reaction and the reaction water.

### CROSS-REFERENCE TO RELATED APPLICATIONS

The preliminary patentability search (US Patents) has enabled to locate the following documents as the closest prior art documents

| Patent No. | Inventor | Year |
|---|---|---|
| 3,432,357 | Dankese | 1969 |
| 4,476,197 | Herceg | 1984 |
| 4,753,857 | Hosaka | 1988 |
| 5,079,105 | Bossel | 1992 |
| 5,268,241 | Meacham | 1993 |
| 5,350,642 | Akagi | 1994 |
| 5,527,634 | Meacham | 1996 |
| 5,549,983 | Yamanis | 1996 |
| 5,770,327 | Barnett et al | 1998 |
| 5,776,625 | Kaufman et al | 1998 |
| 6,040,073 | Okamoto | 2000 |
| 6,048,634 | Kaufman et al | 2000 |
| 6,291,089 B1 | Piascik et al | 2001 |
| 6,361,892 B1 | Ruhl et al | 2002 |
| 6,455,184 B1 | Peinecke | 2002 |
| 6,602,626 B1 | Allen | 2003 |
| 2005/0091838 A1 | Frank et al | 2005 |

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

Field of search: Class 429: subclasses 17, 19, 20, 26, 30, 32, 34, 38, and 39 Class 29: subclass 623.2

### FIELD OF THE INVENTION

The present invention relates to fuel cells in general and a distribution system for the reaction gases and fluids to a cell and a stack assembly in particular.

Polymer electrolyte membrane or proton exchange membrane (PEM) fuel cells have intrinsic benefits and a wide range of applications due to the relatively low operating temperatures, room temperature to around 80° C. or higher, up to ˜160° C., with high temperature membranes. The active portion of a PEM is a membrane sandwiched between an anode and a cathode layer. Fuel gas containing hydrogen is passed over the anode and oxygen (air) is passed over the cathode. The gases react indirectly with each other through the electrolyte (the membrane) generating an electrical voltage between the cathode and the anode. Typical electrical potential of PEM cells can be from 0.5 to 0.9 volts, the higher the voltage the greater the electrochemical efficiency, however at lower cell voltage, the current density is higher but there is a peak value in the power density for a given set of operating conditions. The electrochemical reaction also generates heat and water that must be extracted from the fuel cell. The extracted heat can be used in a cogeneration mode. The water can be used for the humidification of the membrane, for the cooling or dispersed in the environment.

Multiple cells are combined by stacking, interconnecting individual cells in electrical series. The voltage generated by the cell stack is the sum of the individual cell voltages. There are designs that use multiple cells in parallel or in a combination series parallel connection. Separator plates (bipolar plates) are inserted between the cells to separate the anode gases of one cell from the cathode gases of the next cell. These separator plates are typically graphite based or metallic with or without coating. To provide hydrogen to the anode and oxygen to the cathode without mixing, a complex system of gas distribution and seals is required.

The dominant design at present in the fuel cell industry is to use bipolar plates with flow field machined, molded or otherwise impressed in the bipolar plates. An optimized bipolar plate has to fulfill a series of requirements; very good electrical and heat conductivity, gas tightness, corrosion resistance, low weight and low cost. The separator plate flow field design ensures the gas distribution, the removal of product water and the removal of the heat generated. Also required is the design of manifolds for the fluids to ensure that the flow reaches each separator/flow field plate uniformly.

There is a continuous search to innovate in order to increase the power density (weight and volume) of fuel cell stacks and to reduce material and assembly costs.

### BRIEF SUMMARY OF THE INVENTION

Our invention could lead to a significant innovation radically different from the existing dominant technology. Our invention offers an advantageous alternative to the current industry dominant design of using separator plates with flow fields to distribute the reaction gases in a path parallel to the membrane assembly. In our invention, the reaction gases are fed perpendicularly to the membrane plane from a multitude of separate conduits. Typically four different conduits (hydrogen in and out and oxygen (air) in and out) are used as the repeatable unit to cover the active area of the membrane. A separate conduit (in/out) for the water cooling can be added or the water cooling could be integrated to the oxygen (air) exhaust or the hydrogen exhaust. The challenge of the invention is to provide seals to ensure that the anode fuel is prevented from entering the cathode side of the membrane and to ensure that the cathode air is prevented from entering the anode side of the membrane. Among the advantages of the system is that it is scalable without major redesign since the active fuel cell area is subdivided in a repeatable pattern at will. The invention provides the fuel cell and fuel cell stack assembly with a system for fluid distribution. Our system has the following unique elements:
Conduits fulfilling both the manifold and flow field functions are positioned perpendicularly to the membrane electrode assembly plane.
The active membrane area is subdivided in small areas with their own fuel and oxidant supply.
Reaction gases (fuel—hydrogen and oxidant—oxygen/air) are flowing mainly radially and diffusing axially thru porous gas diffusion layer (GDL) to reach the membrane electrode assembly and thus complete the flow field function.
The porous gas diffusion layer (GDL) is a thermally conducting material; heat is flowing axially, i.e. from the electrodes to the separator plates.
The separator plates are a thermally conducting material acting mainly in a radial direction, i.e. in the membrane electrodes assembly (catalyst coated membrane) plane between conduits.
The heat of reaction is extracted by water circulating in the air exhaust conduits (manifolds), separate manifolds and other options are equally possible.
The necessary gas tight seals in the GDL are formed in situ to ensure uniformity, reliability, ease of assembly and lower cost.

The combinations of these unique features constitute the essence of our invention.

### BRIEF DESCRIPTION OF THE SEVERAL VIEWS OF THE DRAWINGS

FIG. 1, the single cell schematic drawing illustrates the basic concept. The air in, air out, hydrogen in, hydrogen out and water thru feed conduits are indicated. The separator plate (1), in-situ seals (4) and edge seals (3) are illustrated. The cross-section 2-2 is reproduced in FIG. 2.

FIG. 2, the cross-section 2-2 of the single cell to illustrate the main components. In the center is the proton exchange membrane (7) sandwiched between anode (6) and cathode (8) catalyzed layers referred to as a CCM (catalyst coated membrane) (6+7+8). Facing the anode and cathode are the gas diffusion layers (GDL) (5) also known as gas diffusion media or porous gas diffusion media. The function of the GDL is to distribute the reaction gases uniformly over the active area of the membrane and to extract the water and heat from the electrochemical reaction. In this invention, the feed conduits (air in and hydrogen in this illustration) are perpendicular to the CCM and the two GDLsThis assembly is referred to as the MEA (membrane electrode assembly). A separator plate (1), also referred to as bipolar plate (sheet, foil), is inserted to separate each cell. The GDL must have seals (4) to prevent mixing of the reaction gases. In our invention the seals are produced in situ, thus ensuring the necessary gas tightness and simplifying the assembly. The edges are sealed (3) in the same way.

FIG. 3 is a basic fuel cell stack assembly schematic illustration. Multiple cells (9) are combined by stacking, interconnecting individual cells in electrical series. Current collectors (10) are inserted between the stack and the fluid distribution manifolds (11). The bottom end plate (12) is illustrated, the top end plate (13) is partly shown and the necessary connecting rods or other assembly methods to maintain the pressure on the stack are not included in the schematic.

FIG. 4, the basic functionality of the fluid distribution—manifold (11) is illustrated with the bottom end plate (12); (air in, air out, hydrogen in, cooling water in and hydrogen out combined with water out). This basic unit can be modified; geometry, size, spacing and spatial arrangements are variables that can be selected over a wide range of values. This basic unit is for illustrative purpose only, it could be vastly different in size and ratio length/width.

FIG. 5 is representative of a different design where the distribution manifolds and end plates are integrated into a single component. The multiple cells (9) are combined by stacking, interconnecting individual cells in electrical series. The current collectors (10) are inserted between the stack and distribution manifold/end plate integrated component inlet (14) outlet (15). The inlet (14) is an assembly of four plates, namely; a perforated distribution plate with three types of feed conduits that is one type for air, one type for hydrogen and one type for water (14-1), a manifold to feed the hydrogen in the designated conduits (14-2), a separator plate between the hydrogen manifold and the other manifolds, (14-3), and an inlet fluid distribution (14-4) described in FIG. 6. The outlet (15) is an assembly of outlet manifolds for air, hydrogen and water combined (15-2) and a perforated distribution plate (15-1). This design is simpler, lighter and more rigid than the design illustrated in FIGS. 3 and 4.

FIG. 6 is an illustration of the modular end plate with flow distribution (14-4). The face plate (14-4-1) is the connecting plate (interface) for the water-in, air-in and hydrogen-in. The separator plate (14-4-2) is the distribution manifold for water in and hydrogen in, (14-4-3) is a separator plate and allows all fluids thru (water, air, hydrogen). The separator (14-4-4) is the distribution manifold for air in. The last plate of the combination distribution manifolds/end plate is (14-4-5) which seals the manifold.

FIG. 7 is an exploded view of the design illustrated in FIG. 5. A multitude of single cell (9) connected in series with a plurality of conduits with integrated gaskets (seals), the current collectors (10), the flow distribution and end plates combination inlet (14) and outlet (15). The details of the combination fluid distribution manifolds/end plate have been given in FIG. 5 and FIG. 6.

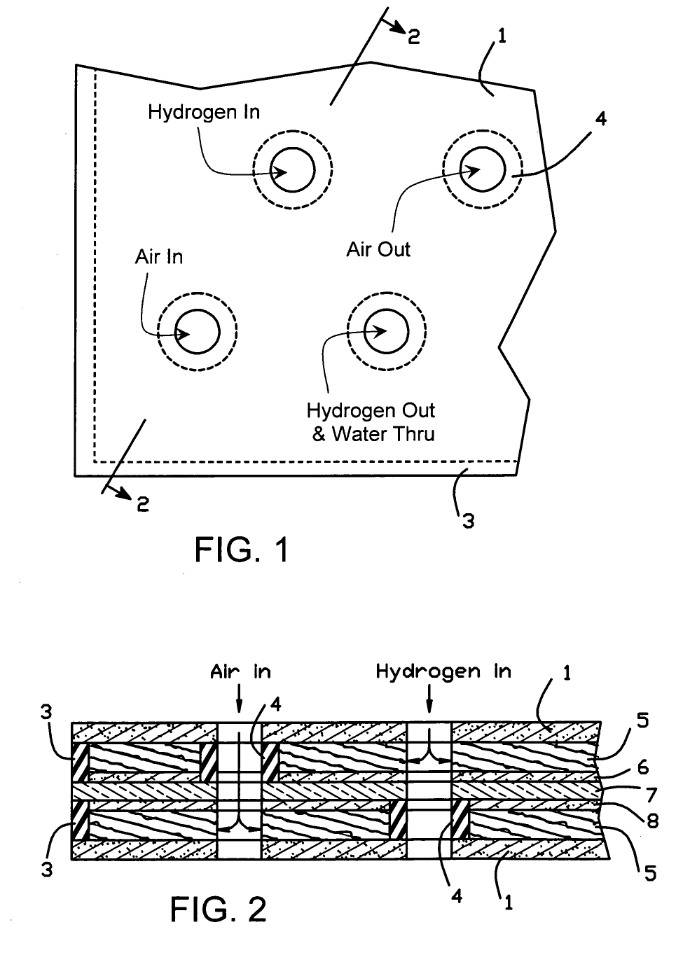

### DETAILED DESCRIPTION OF THE INVENTION

In situ seals

One example of a process to make the in situ seals is given as representative of a wide range of alternatives. The catalyst coated membrane and the gas diffusion layers can either be pre-assembled by pressing under a specified set of temperature, time and pressure or the catalyst coated membrane and the gas diffusion layers are handled separately. The conduit's geometry, size and spacing are all variables that can be selected. The choice is determined to some degree by the application, the operating parameters and the auxiliary equipments. The gas diffusion layers are then precisely perforated to match the seal's location. The appropriate sealing material is prepared and injected in the openings (perforations in the GDL) and cured. The gasket material is selected for the compatibility with the membrane and the catalysts and to have the required mechanical, thermal, electrical and viscous properties to provide an adequate seal in reference to gas tightness, mechanical strength durability and reliability. The edge seals can also be done by a number of alternatives. Once the integrated gaskets are formed the assembly CCM+GDL+ separator plates are perforated. The individual cells with the plurality of conduits are then ready for assembly. Again numerous alternatives are possible to align and compress the stack of cells. Current collectors are positioned at each extremity and the manifold—end plate combination completes the stack assembly. Pressure is applied and maintained by mechanical means. Two examples are described as illustrative of the many possibilities can be proposed by a person skilled in the art.

### EXAMPLE 1

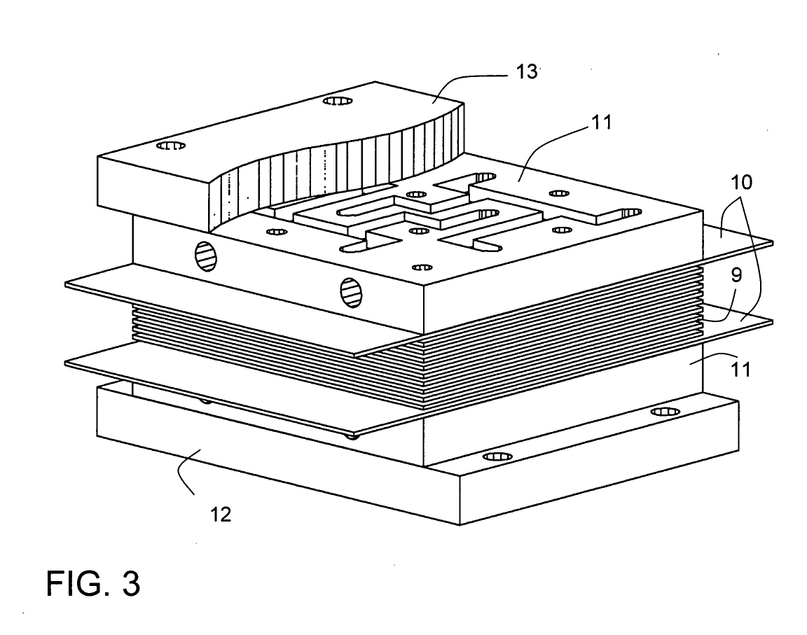

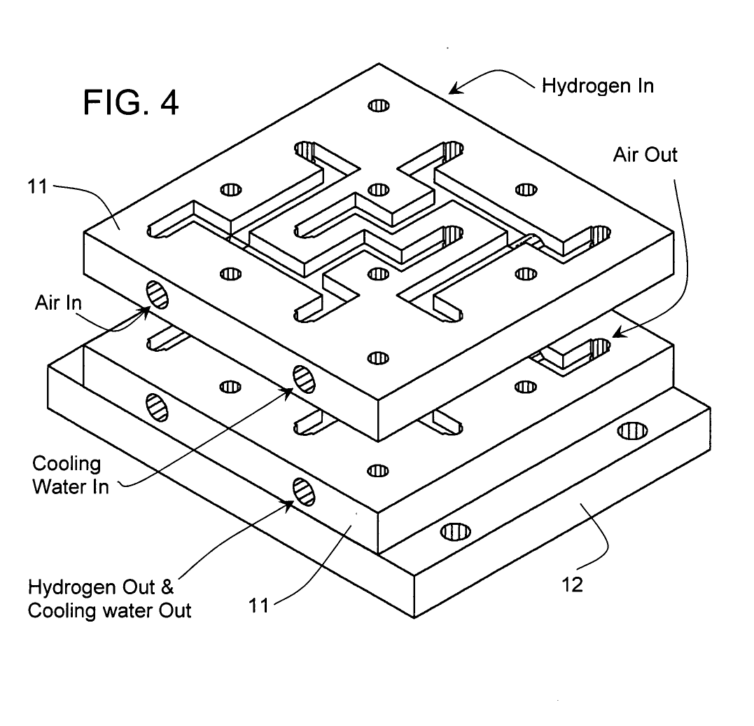

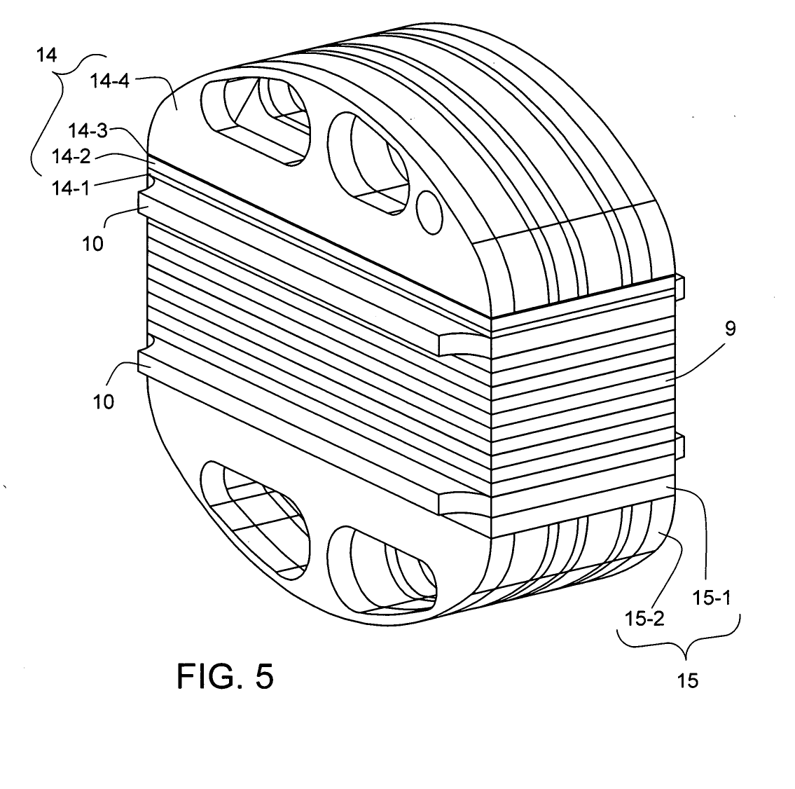

FIG. 3 and FIG. 4 illustrate a stack assembly with a basic concept of the fluid distribution.

Once the membrane and the porous gas diffusion media have been selected, in the present case Nafion™ membrane and GDL from SGL Carbon Group, the catalyst coated membrane (membrane plus platinum) and the porous gas diffusion media are pressed together according to the recommendation of the manufacturers regarding temperature, pressure and time. The geometry, size and number of conduits are selected based on the operating conditions and the required power per cell and total power. The first step is then to prepare the assembly CCM-GDL for the integrated gaskets on the anode and cathode side of the membrane and to mold the gaskets. The final step prior to assembly is to pierce the gaskets and membrane.

The assembled individual cells are then stacked inserting a separator/bipolar plate between each cell. Current collectors (10) complete the stack, the fluid distribution manifold (11) is then added and finally the end plates (12, 13) and tie-rods (missing from the figure) compress the stack. Fittings for oxygen/air, hydrogen, and water are then attached to the manifold and the stack is ready to be put in operation.

### EXAMPLE 2

FIGS. 5, 6 and 7 illustrate a variant of the basic concept. The significant modifications are in the fluid manifold and end plates design.

FIG. 5—The catalyst coated membrane and the porous gas diffusion media, in the present case Ion-Power CCM with Nafion™ membrane, and SGL 34BC GDL, are pressed together according to the recommendation of the manufacturers regarding temperature, pressure and time. The geometry, size and number of conduits are selected based on the operating conditions and the required power per cell and total power. The assembly CCM-GDL is prepared by mechanically making the openings in the GDL for the integrated gaskets on the anode and cathode side of the membrane. A silicone based product with an inert carbon base additive is injected and the gaskets are cured. The final step prior to assembly is to pierce the gaskets together with the CCM and the GDL on the opposite side.

The assembled individual cells (9) are then stacked. Current collectors (10) complete the stack. In this example the combination fluid distribution manifold and end plates (14) are added and the system is compressed by elastic wrapping around the stack, not shown in the figure. Fittings for oxygen/air, hydrogen and water are then attached to the manifold and the stack is ready to be put in operation.

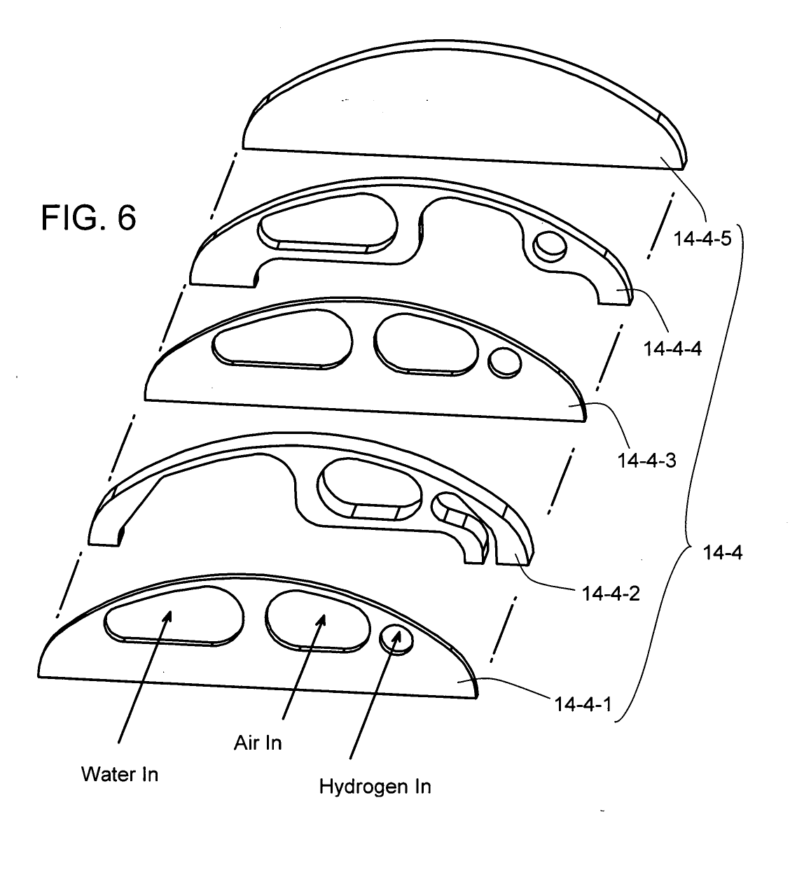

FIG. 6—An exploded view of the combination end plate (structural function) and manifold (fluid distribution) (14-4). This design and variants on the same idea have several advantages over the basic intuitive concept of Example 1:
Combine two functions—structural and fluid distribution
Lighter than the design with separate components
Easier to fabricate and lower cost of the manifold
More flexibility in the design
More uniform distribution of the fluids

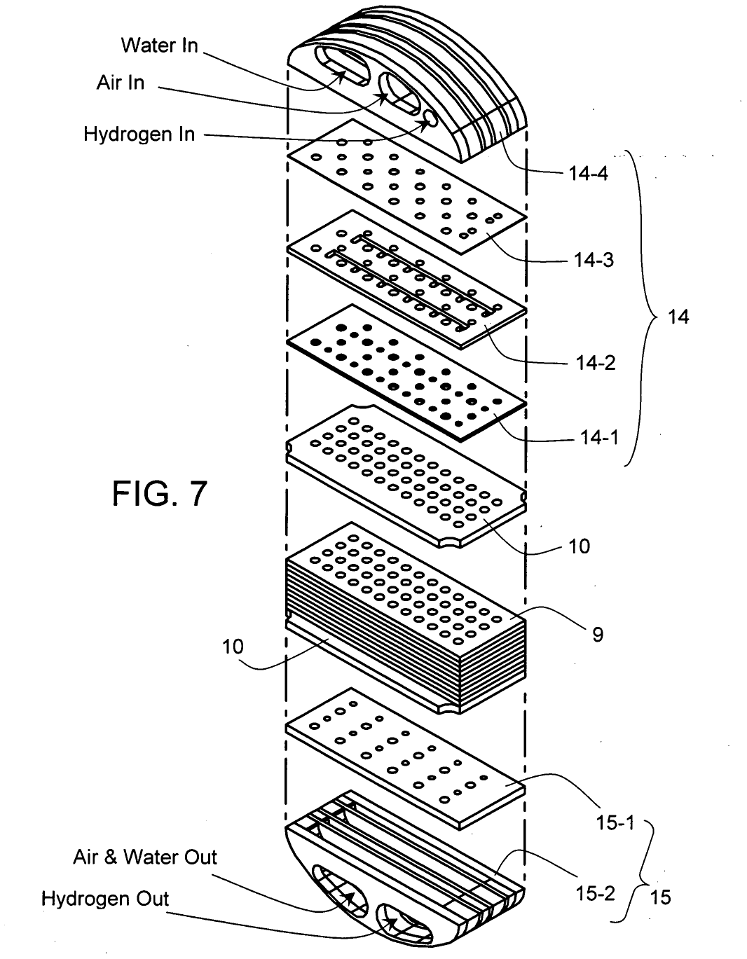

FIG. 7—An illustration of the several components for this example. The number of conduits, 48, is totally arbitrary and only illustrative of the concept of plurality of conduits. The illustrated conduits pattern is a rectangular matrix; however one can easily use other geometries. In this example three separate conduits are used for the inlet and two for the outlet, therefore the cooling conduits must be either combined with the air or hydrogen exhaust, in the illustration air and water are combined.

The core of the fuel cell is the catalyst coated electrolyte membrane (6+7+8), sandwiched between the cathode GDL (5) and the anode GDL (5). Each cathode and anode has integrated gaskets; on cathode side (4) and on anode side (4). These integrated gaskets ensure that the anode fuel is prevented from entering the cathode side of the membrane and the air prevented from entering the anode side. The water cooling conduits in this example are combined with the air exhaust conduits which is also the exhaust for the reaction water. The first and the last cell are connected in series with the current collectors (10). The distributor plates (14-1, 14-2, and 14-3) are inserted between the current collector (10) and the fluid manifold (14-4).

What is claimed is:

1. A solid electrolyte membrane fuel cell comprising a plurality of conduits that penetrate the catalyst coated membrane and the porous gas diffusion layers in a perpendicular direction to the catalyst coated membrane plane, the conduits have appropriately positioned integrated gaskets to provide reactant gases to the anode or cathode and to ensure that the anode fuel is prevented from entering the cathode side of the membrane and vice-versa, a water cooling path to extract the heat from the electrochemical reaction, each conduit is fully separated from each other by an active area of the solid electrolyte membrane.

2. The fuel cell of claim 1 wherein the conduits are located so the fuel (hydrogen or hydrogen rich mixture) is distributed in a radial direction in the porous gas diffusion layers from fuel inlet conduits to fuel outlet conduits.

3. The fuel cell of claim 1 wherein the conduits are located so the oxidant (oxygen/air) is distributed in a radial direction in the porous gas diffusion layers from oxidant inlet conduits to oxidant outlet conduits.

4. The fuel cell of claim 1 wherein the conduits are located so the electrochemical reaction by-product water is removed in a radial direction in the porous gas diffusion layers from air/oxygen inlet conduits to air/oxygen outlet conduits.

5. The fuel cell of claim 1 wherein the conduits are located so the oxidant exhaust and cooling fluid are combined in outlet conduits.

6. The fuel cell of claim 1 wherein the conduits are located so the fuel exhaust and cooling fluid are combined in outlet conduits.

7. The fuel cell of claim 1 wherein the gaskets fully isolate the anode flow from the cathode flow; the gaskets are fabricated in situ with a material compatible with the membrane and the catalyst coated layer.

8. The gasket material in claim 1 consisting of silicone based elastomers.

9. The gasket material in claim 1 consisting of silicone based elastomers with inert additives.

10. The gasket material in claim 1 consisting of polyurethane elastomers.

11. The gasket material in claim 1 consisting of polyurethane elastomers with inert additives.

12. The gasket material in claim 1 consisting of thermoset elastomers.

13. The gasket material in claim 1 consisting of thermoset elastomers with inert additives.

14. The inert additives in claim 9 wherein the additives are carbon based.

15. The inert additives in claim 9 wherein the additives are silicon dioxide based.

16. The inert additives in claim 9 wherein the additives are aluminum oxide based.

17. The inert additives in claim 9 wherein the additives are ceramic based.

18. The inert additives in claim 11 wherein the additives are carbon based.

19. The inert additives in claim 111 wherein the additives are silicon dioxide based.

20. The inert additives in claim 11 wherein the additives are aluminum oxide based.

21. The inert additives in claim 11 wherein the additives are ceramic based.

22. The inert additives in claim 13 wherein the additives are carbon based.

23. The inert additives in claim 13 wherein the additives are silicon dioxide based.

24. The inert additives in claim 13 wherein the additives are aluminum oxide based.

25. The inert additives in claim 13 wherein the additives are ceramic based.

26. The porous gas diffusion layers in claim 1 wherein the gas diffusion layer porosity is between 60 and 90 percent.

27. The porous gas diffusion layers in claim 1 wherein the gas diffusion layer average pore size is between 5 and 50 microns.

28. The porous gas diffusion layers in claim 1 wherein the gas diffusion layer thickness is between 50 and 500 microns.

29. The catalyst coated membrane in claim 1 wherein the membrane is perfluorosulfonic acid polymer based.

30. The catalyst coated membrane in claim 1 wherein the membrane is a poly-benzimidazole (PBI) temperature resistant polymer.

31. The catalyst coated membrane in claim 1 wherein the membrane is an engineered hydrocarbon membrane.

32. The catalyst coated membrane in claim 1 wherein the membrane is a sulfonated poly ether ketone (SPEEK).

33. The conduits in claim 1 wherein the conduit geometry provide uniform distribution of the reactants.

34. The conduits in claim 1 wherein the size is between about 1 to 5 mm.

35. The conduits in claim 1 wherein the conduits are distributed in a repeatable parallelogram unit to create a two dimensional pattern.

36. The conduits in claim 1 wherein the combined cross-sectional area of the conduits total between about 10 and 50 percent of the total active area of the fuel cells.

37. The porous gas diffusion layers in claim 1 wherein the material is hydrophobic.

38. The porous gas diffusion layers in claim 1 wherein the material has hydrophobic region in contact with the catalyst coated membrane and has hydrophilic region in contact with the separator plates.

39. A fuel cell stack of two or more fuel cells connected in series, the stack comprising a plurality of fuel cells, a plurality of separator plates between each fuel cell with openings matching the conduits in the individual fuel cells, two fluid distribution manifolds with fluid flows that register with the openings in the separator plates and the conduits in the fuel cells, said fluid distribution manifolds having external ports for the fluids inlets and outlets, two current collectors, two end plates disposed on opposing sides of the said plurality of fuel cells to maintain the stack under compression.

40. The fluid distribution manifold function and end plate mechanical function in claim 39 wherein these two functions are accomplished by separate components.

41. The fluid distribution manifold function and end plate mechanical function in claim 39 wherein these two functions are combined in an integrated component.

42. The separator plates and the bipolar plates in claim 39 wherein the material is both a good electrical conductor to connect electrically the individual cells and a good thermal conductor to extract the heat of reaction in mostly radial direction toward the cooling water circulation conduits.

43. The separator plates material in claim 39 wherein the material is; graphite, flexible graphite, expanded graphite, electrically conductive composites, coated metallic, uncoated metallic.
